(19) United States
(12) Patent Application Publication
(10) Pub. No.: US 2024/0244424 A1
(43) Pub. Date: Jul. 18, 2024

(54) LAYER-2 SECURITY ENHANCEMENTS

(71) Applicant: Apple Inc., Cupertino, CA (US)

(72) Inventors: Christian Hofmann, Munich (DE); Panagiotis Botsinis, Munich (DE); Sameh M. Eldessoki, Munich (DE); Tarik Tabet, Carlsbad, CA (US)

(21) Appl. No.: 18/414,861

(22) Filed: Jan. 17, 2024

(30) Foreign Application Priority Data
Jan. 18, 2023 (GR) 20230100033

(51) Int. Cl. H04W 12/00; H04W 12/033

(52) U.S. Cl. CPC H04W 12/009; H04W 12/033

(57) ABSTRACT

Disclosed are methods, systems, and computer-readable medium to perform operations including generating a layer-2 (L2) header block for a medium access control (MAC) subprotocol data unit (subPDU), the MAC subPDU including a MAC service data unit (SDU) that includes an internet protocol (IP) packet; ciphering at least a portion of the L2 header block; and assembling a transport block that includes the ciphered portion of the L2 header block in the MAC subPDU.

### CROSS-REFERENCE TO RELATED APPLICATIONS

This application claims priority to Greek patent application Ser. No. 20/230,100033, filed on Jan. 18, 2023, which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency- division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

A wireless communication network can use various security mechanisms to secure the network. Some of the security mechanisms are used to secure messages (e.g., signaling messages, data, etc.) that are exchanged between the wireless communication network and user devices. One security mechanism is called ciphering or encryption. Ciphering, which can be applied to user plane (U-Plane) data and control plane (C-Plane) data, involves using a ciphering algorithm to encrypt the data such that the data cannot be read or modified. Another mechanism is called integrity protection. Integrity protection uses an integrity protection algorithm, such as Message Authentication Code-Integrity (MAC-I), to protect the data such that the data cannot be modified. The wireless communication network can use ciphering and/or integrity protection to secure certain messages or data. Additionally, the wireless communication network can instruct user devices served by the network to use ciphering and/or integrity protection to secure certain messages or data.

### SUMMARY

In accordance with one aspect of the present disclosure, a method to be performed by a user equipment (UE) involves generating a layer-2 (L2) header block for a medium access control (MAC) subprotocol data unit (subPDU), the MAC subPDU including a MAC service data unit (SDU) that includes an internet protocol (IP) packet; ciphering at least a portion of the L2 header block; and assembling a transport block that includes the ciphered portion of the L2 header block in the MAC subPDU.

Other versions include corresponding systems, apparatus, and computer programs to perform the actions of methods defined by instructions encoded on computer readable storage devices. These and other versions may optionally include one or more of the following features.,

In some implementations, the L2 header block includes at least one of a MAC Sub-PDU header (MAC SH), a MAC Message Authentication Code (M MACI), a Service Data Adaptation Protocol (SDAP) header, a Packet Data Convergence Protocol (PDCP) header, or a Radio Link Control (RLC) header.

In some implementations, the portion of the L2 header block involves the M MACI, the SDAP header, the PDCP header, and the RLC header.

In some implementations, the method further involves ciphering, based on a ciphering offset, at least a portion of the MAC SDU.

In some implementations, the ciphered portion of the MAC SDU includes at least one of: an IP header or a portion of the IP packet.

In some implementations, the portion is a first portion, and the method further involves integrity protecting at least a second portion of the L2 header block.

In some implementations, the second portion of the L2 header block involves one of: a first MAC Sub-PDU header (MAC SH) of a plurality of MAC SHs, a Service Data Adaptation Protocol (SDAP) header, a Packet Data Convergence Protocol (PDCP) header, and a Radio Link Control (RLC) header; the first MAC SH; the plurality of MAC SHs; or the plurality of MAC SHs, the SDAP header, the PDCP header, and the RLC header.

In some implementations, the method further involves integrity protecting, based on an integrity protection offset, at least a portion of the MAC SDU, where the integrity protected portion of the MAC SDU includes at least one of: an IP header or a portion of the IP packet.

In some implementations, the IP packet is a first encrypted IP packet, and the method further involves: establishing a secure data radio bearer (DRB) with a receiver; mapping, using a traffic flow template (TFT) filter, a second unsecured IP packet to a secure quality of service (QoS) flow, where the unsecured IP packet is not ciphered or integrity protected; and mapping the secure QoS flow to the secure DRB.

In some implementations, the method further involves in the secure DRB, performing at least one of: ciphering the unsecured IP packet; or integrity protecting the unsecured IP packet.

In some implementations, the method further involves mapping the first encrypted IP packet to a second DRB different from the secure DRB.

In some implementations, the method further involves transmitting the transport block to a receiver.

In some implementations, the method further involves performing, based on at least one of an integrity protection offset or a ciphering offset, at least one of ciphering or integrity protection of at least a portion of the MAC SDU, where the at least one of the integrity protection offset or the ciphering offset has a corresponding standardized index in a mapping table.

In some implementations, the method further involves determining the at least one of the integrity protection offset or the ciphering offset based on one of: a hardware capability of a transmitter performing the least one of ciphering or integrity protection, a logical channel (LC) for the IP packet, a radio bearer (RB) type for the IP packet, a Quality of Service (QoS) flow for the IP packet, application layer information for the IP packet, or a security class of the transmitter.

In some implementations, determining the at least one of the integrity protection offset or the ciphering offset is based on the RB type involves: determining that the RB type is a Voice over IP (VoIP); and in response, determining that the at least one of the integrity protection offset or the ciphering offset covers at least one of an IP header, a User Datagram Protocol (UDP) header, or a Real-time Transport Protocol (RTP) header.

In some implementations, determining the at least one of the integrity protection offset or the ciphering offset is based on the security class of the transmitter involves: determining that the transmitter is assigned a secure security class; and in response, determining that the at least one of the integrity protection offset or the ciphering offset covers the IP packet and an IP header.

In some implementations, the method further involves determining the at least one of the integrity protection offset or the ciphering offset by selecting portions of the IP packet to cipher and/or integrity protect; including the at least one of the integrity protection offset or the ciphering offset in a MAC subheader to signal the offsets to a receiver.

In accordance with another aspect of the present disclosure, a method involves receiving a transport block including a medium access control (MAC) subprotocol data unit (subPDU), the

MAC subPDU including a MAC service data unit (SDU) that includes an internet protocol (IP) packet; and in a MAC layer of the receiving device, using an authentication algorithm and a ciphering algorithm to determine contents of a L2 header block of the MAC subPDU.

Other versions include corresponding systems, apparatus, and computer programs to perform the actions of methods defined by instructions encoded on computer readable storage devices. These and other versions may optionally include one or more of the following features.

In some implementations, the method further involves determining, based on an integrity protection offset and a ciphering offset, a protected portion of the IP packet and an IP header; and in the MAC layer of the receiving device, using the authentication algorithm and the ciphering algorithm to determine contents of the protected portion of the IP packet and the IP header.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1A illustrates an example protocol stack in an existing radio access network.

FIG. 1B illustrates an example transmit operation in which an IP packet is transmitted using the protocol stack of FIG. 1A.

FIG. 2 illustrates an example wireless network, according to some implementations.

FIG. 3 illustrates example integrity protection options in a MAC layer, according to some implementations.

FIG. 4 illustrates example ciphering in a MAC layer, according to some implementations.

FIG. 5 illustrates an example of ciphering and integrity protection in the MAC layer using ciphering and integrity protection offsets, according to some implementations.

FIG. 6A illustrates an example MAC header, according to some implementations.

FIG. 6B illustrates an example MAC Message Authentication Code-Integrity (MAC-I), according to some implementations.

FIG. 7 illustrates example input parameters for L2 header generation, integrity protection, and ciphering, according to some implementations.

FIG. 8A, 8B illustrate examples of mapping unsecured data to a secure DRB, according to some implementations.

FIG. 9A illustrates a flowchart of an example method, according to some implementations.

FIG. 9B illustrates a flowchart of another example method, according to some implementations.

FIG. 10 illustrates an example user equipment (UE), according to some implementations.

FIG. 11 illustrates an example access node, according to some implementations.

### DETAILED DESCRIPTION

In existing wireless communication networks, user equipment (UE) devices cipher and/or integrity protect data above a Service Data Adaptation Protocol (SDAP), such as Internet protocol

(IP) data, before transmitting the data to a base station of a radio access network (RAN). In these networks, UEs cipher and/or integrity protect IP headers and payloads, but do not cipher or integrity protect some Layer 2 (L2) headers, such as radio link control (RLC) and medium access control (MAC) headers.

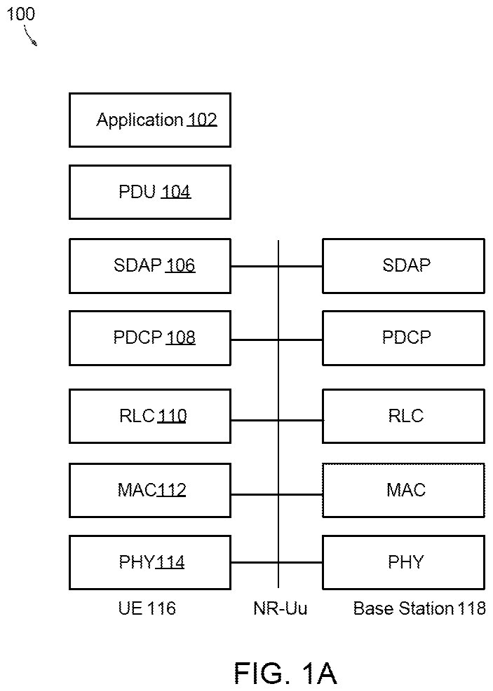

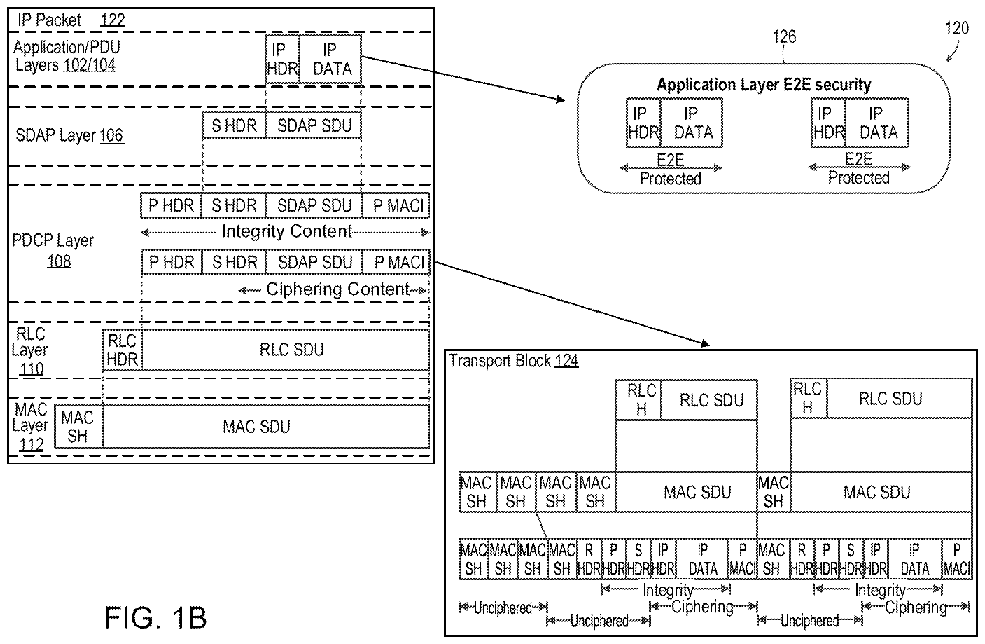

FIG. 1A illustrates an example protocol stack 100 in an existing RAN. The protocol stack 100 enables communication between a UE 116 and a base station 118 via a wireless interface, such as a new radio (NR)-Uu interface. As shown in FIG. 1A, on the UE side, the protocol stack 100 includes an application layer 102, a protocol data unit (PDU) layer 104, an SDAP layer 106, a packet data convergence protocol (PDCP) layer 108, an RLC layer 110, a MAC layer 112, and a physical (PHY) layer 114. The L2 includes MAC layer 112, RLC layer 110, PDCP layer 108, and SDAP layer 106.

FIG. 1B illustrates an example transmit operation 120 in which an IP packet 122 is transmitted using the protocol stack 100. As shown in FIG. 1B, the UE 116 performs integrity protection and ciphering in the PDCP layer 108. In particular, the UE 116 integrity protects a PDCP header (P HDR), an SDAP header (S HDR), and an SDAP Service Data Unit (SDU). Further, the UE 116 ciphers the SDAP SDU and a PDCP Message Authentication Code (P MACI). As also shown in FIG. 1B, the UE 116 may assemble a transport block 124 that includes one or more IP packets 122. As shown by block 126, applications executed by the UE 116 can encrypt IP data end-to-end (E2E) in the application layer 102 or in the PDU layer 104 (e.g., on the IP level). Thus, the data that is encrypted in the UE 116 is only decrypted in the application layer of a destination node.

These existing protocols, however, leave certain potential vulnerabilities that can affect the security and/or efficiency of the network. One potential vulnerability is that network attackers can read unciphered data (e.g., RLC and MAC headers), e.g., to discover traffic patterns and/or use of applications or services. Attackers can also insert forged MAC control elements (CEs) or RLC headers to break the connection between the UE and the base station. The attacks may result in SCell deactivation and/or sequence number (SN) window stalling, among other disruptions.

Additionally, various factors, such as increasing peak data throughput rates and real-time demands, require an increasing amount of dedicated hardware on the modem side to cipher and/or integrity protect the data on a per packet basis. Hardware designs need to satisfy those throughput requirements even though: (i) peak throughput is rare in practice, (ii) the payload may already be ciphered/integrity protected E2E in the application layer 102 or in the PDU layer 104 (e.g., on the IP level), and (iii) 3GPP ciphering/integrity protection is only protecting the link between the UE and the base station, which is only one hop in the network. These factors become especially cumbersome considering that a significant portion of a MAC PDU is already ciphered and/or integrity protected. For example, assuming a 1500-byte SDAP SDU, approximately 99% of the MAC PDU is ciphered and/or integrity protected.

In sum, existing modems in UEs do not cipher and/or integrity protect vulnerable data, such as L2 headers. Existing modems also require increasing amounts of hardware to cipher/integrity protect each byte for the single hop between a UE and a base station, even though the packets are likely already to be encrypted in the application layer or the PDU layer. Further, modems are being designed to account for maximum throughput, even though maximum throughput rarely occurs in practice.

This disclosure provides systems and methods for efficiently implementing ciphering and/or integrity functionality.

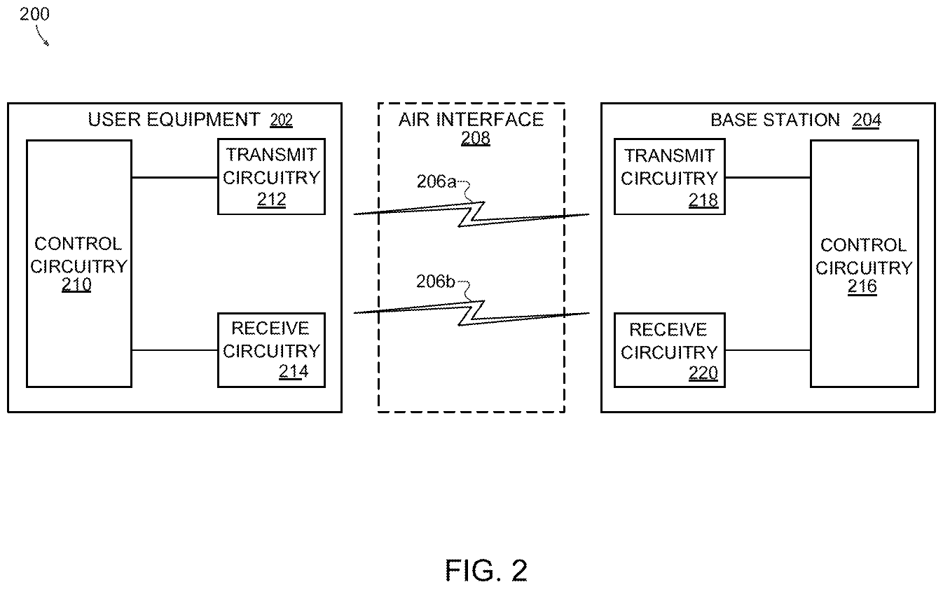

FIG. 2 illustrates an example wireless network 200, according to some implementations. The wireless network 200 includes a UE 202 and a base station 204 connected via one or more channels 206A, 206B across an air interface 208. The UE 202 and base station 204 communicate using a system that supports controls for managing the access of the UE 202 to a network via the base station 204.

In some implementations, the wireless network 200 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 200 may be an E-UTRA (Evolved Universal Terrestrial Radio Access)-NR Dual Connectivity (EN-DC) network, or an NR-EUTRA Dual Connectivity (NE-DC) network. In some other implementations, the wireless network 200 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology, or the like.

While aspects may be described herein using terminology commonly associated with 5G NR, aspects of the present disclosure can be applied to other systems, such as 3G, 4G, and/or systems subsequent to 5G (e.g., 6G).

In the wireless network 200, the UE 202 and any other UE in the system may be, for example, any of laptop computers, smartphones, tablet computers, machine-type devices such as smart meters or specialized devices for healthcare, intelligent transportation systems, or any other wireless devices. In the wireless network 200, the base station 204 provides the UE 202 network connectivity to a broader network (not shown). This UE 202 connectivity is provided via the air interface 208 in a base station service area provided by the base station 204. In some implementations, such a broader network may be a wide area network operated by a cellular network provider or may be the Internet. Each base station service area associated with the base station 204 is supported by one or more antennas integrated with the base station 204. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 202 includes control circuitry 210 coupled with transmit circuitry 212 and receive circuitry 214. The transmit circuitry 212 and receive circuitry 214 may each be coupled with one or more antennas. The control circuitry 210 may include various combinations of application-specific circuitry and baseband circuitry. The transmit circuitry 212 and receive circuitry 214 may be adapted to transmit and receive data, respectively, and may include radio frequency (RF) circuitry and/or front-end module (FEM) circuitry.

In various implementations, aspects of the transmit circuitry 212, receive circuitry 214, and control circuitry 210 may be integrated in various ways to implement the operations described herein. The control circuitry 210 may be adapted or configured to perform various operations, such as those described elsewhere in this disclosure related to a UE.

The transmit circuitry 212 can perform various operations described in this specification. Additionally, the transmit circuitry 212 may transmit using a plurality of multiplexed uplink physical channels. The plurality of uplink physical channels may be multiplexed, e.g., according to time division multiplexing (TDM) or frequency division multiplexing (FDM), along with carrier aggregation. The transmit circuitry 212 may be configured to receive block data from the control circuitry 210 for transmission across the air interface 208.

The receive circuitry 214 can perform various operations described in this specification. Additionally, the receive circuitry 214 may receive a plurality of multiplexed downlink physical channels from the air interface 208 and relay the physical channels to the control circuitry 210.

The plurality of downlink physical channels may be multiplexed, e.g., according to TDM or FDM, along with carrier aggregation. The transmit circuitry 212 and the receive circuitry 214 may transmit and receive, respectively, both control data and content data (e.g., messages, images, video, etc.) structured within data blocks that are carried by the physical channels.

FIG. 2 also illustrates the base station 204. In some implementations, the base station 204 may be a 5G RAN, a new generation (NG) RAN, an E-UTRAN, a non-terrestrial cell, or a legacy RAN. The UE 202 utilizes connections (or channels) 206A, 206B, each of which includes a physical communications interface or layer.

The base station 204 circuitry may include control circuitry 216 coupled with transmit circuitry 218 and receive circuitry 220. The transmit circuitry 218 and receive circuitry 220 may each be coupled with one or more antennas that may be used to enable communications via the air interface 208. The transmit circuitry 218 and receive circuitry 220 may be adapted to transmit and receive data, respectively, to any UE connected to the base station 204. The transmit circuitry 218 may transmit a plurality of downlink subframes on downlink physical channels. The receive circuitry 220 may receive a plurality of uplink physical channels from one or more UEs, including the UE 202.

In FIG. 2, the one or more channels 206A, 206B are illustrated as an air interface to enable communicative coupling, and can be consistent with cellular communications protocols, such as a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 202 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and/or a Physical Sidelink Broadcast Channel (PSBCH).

In some implementations, the UE 202 is configured to communicate with the base station 204 by transmitting messages that include signaling information and/or user data. The UE 202 is configured to use security mechanisms to secure the communications with the base station 204. In some examples, the UE 202 is configured to use ciphering and/or integrity protection to secure the communications. Similarly, the base station 204 can use ciphering and/or integrity protection to secure communications with the UE 202. The following disclosure describes security mechanisms that are applied by the UE 202 in communications with the base station 204.

However, the same security mechanisms can be applied by the base station 204 in communications with the UE 202.

In some implementations, the UE 202 is configured to perform ciphering and/or integrity protection in the MAC layer. In these implementations, the ciphering and/or integrity protection functionality is moved from the PDCP layer to the MAC layer. To support the ciphering and/or integrity protection functionality in the MAC layer, the UE 202 is configured to add a sequence number (SN) of 8 or 16 bits to the MAC headers. Doing so increases the length of the MAC headers by one byte (8 bits) or two bytes (16 bits). Additionally, the UE 202 is configured to add a MAC Message Authentication Code-Integrity (M MAC-I) to the MAC headers. In these implementations, the maximum L2 overhead per MAC PDU is 16 bytes. In particular, the maximum L2 overhead includes 3 MAC bytes, 2 MAC SN bytes, 4 MAC-I bytes, 3 RLC bytes, 3 PDCP bytes, and 1 SDAP byte.

In some implementations, the UE 202 is configured to apply integrity protection to one or more L2 headers of a MAC PDU. The L2 headers can include a MAC Sub-PDU Header (MAC

SH), an SDAP header (S HDR), a PDCP header (P HDR), and an RLC header (R HDR). In some implementations, the UE 202 is configured to apply integrity protection to all L2 headers, including the MAC SH, the SDAP header (S HDR), the PDCP header (P HDR), and the RLC header (R HDR). This is referred to as “Integrity Protection Option 1.” In some other implementations, referred to as “Integrity Protection Option 2,” the UE 202 is configured to integrity protect the MAC SH, which is the unciphered MAC header of a PDU. In some other implementations, referred to as “Integrity Protection Option 3,” in addition to integrity protecting the MAC SH, the UE 202 is configured to integrity protect one or more MAC SHs that precede the MAC PDU. In still other implementations, referred to as “Integrity Protection Option 4,” the UE 202 is configured to integrity protect all L2 headers (e.g., MAC SH, S HDR, P HDR, and R HDR) and one or more preceding MAC SHs (if any).

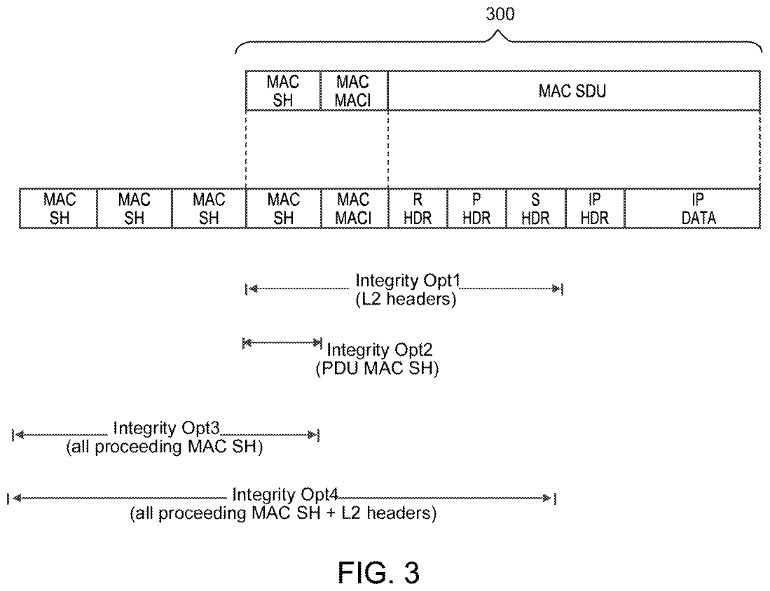

FIG. 3 illustrates example integrity protection options in a MAC layer, according to some implementations. As shown in FIG. 3, Integrity Protection Option 1, involves the UE 202 applying integrity protection to all L2 headers of a MAC PDU 300, including the MAC SH, the SDAP header (S HDR), the PDCP header (P HDR), and the RLC header (R HDR). Integrity Protection Option 2 involves the UE 202 applying integrity protection to the MAC SH of the MAC PDU 300. Integrity Protection Option 3 involves the UE 202 applying integrity protection to the MAC SH of the MAC PDU 300 and one or more MAC SHs that precede the MAC PDU 300 (if any). Integrity Protection Option 4 involves the UE 202 applying integrity protection to all L2 headers of the MAC PDU 300 and one or more preceding MAC SHs (if any). The UE 202 can be preconfigured to use one of the options. Alternatively, the UE 202 and the base station 204 can communicate to select one of the options. For instance, the UE 202 and the base station 204 can communicate using Radio Resource Control (RRC) signaling or the options could be indicated within the MAC SH.

In some implementations, the UE 202 is configured to cipher at least a portion of the MAC PDU. In some instances, the UE 202 is configured to cipher an M MAC-I, an SDAP header (S HDR), a PDCP header (P HDR), and an RLC header (R HDR). In such instances, the SDAP SDUs (IP packets) and the MAC SH are unciphered. In other instances, one or more other portions of the MAC PDU can be ciphered.

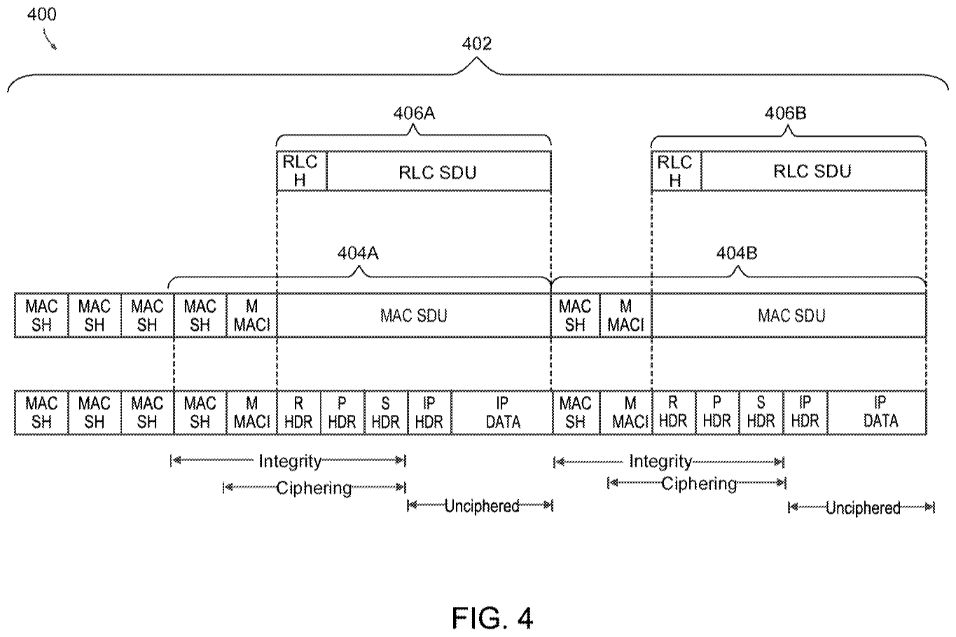

FIG. 4 illustrates example ciphering 400 in the MAC layer, according to some implementations. As shown in FIG. 4, a transport block 402 includes two MAC subPDUs 404A, 404B. The UE 202 is configured to cipher the SDAP header (S HDR), the PDCP header (P HDR), and the RLC header (R HDR) in a MAC SDU of each MAC subPDU. As shown, the UE 202 partially ciphers MAC SDU 406A of MAC subPDU 404A and partially ciphers MAC SDU 406B of MAC subPDU 404B. Additionally, the UE 202 is configured to cipher the M MAC-I of each of the MAC subPDUs 404A, 404B. The SDAP SDUs (IP packets) and the MAC SH, are unciphered. Note that the UE 202 is configured to perform ciphering and/or integrity protection for each MAC subPDU that will be included in the transport block 402.

In the described implementations, the UE 202 ciphers and integrity protects L2 headers, including SDAP, PDCP, and RLC headers. Thus, unlike in existing networks, manipulation of these headers is not possible once they have been transmitted. Also, the UE 202 can integrity protect MAC subheaders and/or MAC CEs. Thus, unlike in existing systems, manipulation of MAC subheaders and/or MAC CEs is not possible after transmission. Furthermore, the number of bytes that the UE 202 processes for protection is significantly reduced compared to existing networks. As an example, consider a transport block that includes an 8000-byte IP packet and 16-byte L2 headers. In this example, if the UE 202 ciphers/integrity protects L2 headers using the described implementations, the number of bytes ciphered/integrity protected is 16 bytes out of 8016 bytes, which is approximately 0.2% of the MAC PDU. As another example, consider a transport block that includes a 1500-byte IP packet and 16-byte L2 headers. In this example, if the UE 202 ciphers/integrity protects L2 headers using the described implementations, the number of bytes ciphered/integrity protected is 16 bytes out of 1516 bytes, which is approximately 1.0% of the MAC PDU. Thus, compared to existing networks that cipher/integrity protect +95% of MAC PDUs, the disclosed implementations achieve a significant reduction in ciphering/integrity protection requirements.

This decrease in ciphering results in a corresponding reduction of associated hardware resources (e.g., area and/or power of modem hardware) as ciphering throughput is reduced drastically. Thus, “on-the-fly” processing, which is described in more detail below, is possible.

Specifically, a short time after the UE 202 receives an uplink (UL) grant and assembles the transport block, the UE 202 creates and ciphers the L2 header block on-the-fly, and then pushes the ciphered L2 header into L1 memory. This operation is more memory efficient than existing networks. Furthermore, because the protection is applied on a MAC PDU level (and not on the transport block level), offline processing of many parts of the transport block is possible. For example, the UE 202 can prepare and store MAC PDUs until the transport block assembly starts. Note that although the MAC headers and MAC CEs are unciphered in the described implementations, they cannot be manipulated as they are integrity protected.

In some implementations, in addition to the previously described ciphering and integrity protection functionality, the UE 202 is configured to perform additional ciphering and/or integrity protection based on a ciphering offset (C-Offset) and/or an integrity protection offset (I-Offset), respectively. The ciphering/integrity protection offsets define how much of the higher layer data is ciphered and/or integrity protected. In some examples, the UE 202 is configured to select the C-Offset and/or the I-Offset based on one or more factors. In these examples, the UE 202 can signal the ciphering/integrity protection offsets in the MAC header for a recipient node (e.g., the base station 204) to determine the portions of the higher layer data that is ciphered and/or integrity protected.

In some implementations, the C-Offset and/or the I-Offset can extend into an SDAP SDU such that the ciphering and/or integrity protection includes IP headers (e.g., outer IP layer data). Additionally and/or alternatively, the offset(s) can extend into an SDAP SDU such that the ciphering and/or integrity protection includes IP and Transmission Control Protocol (TCP) headers; or IP, User Datagram Protocol (UDP), or Real-time Transport Protocol (RTP) headers. Additionally and/or alternatively, the offset(s) can extend into an SDAP SDU such that the ciphering and/or integrity protection includes an Ethernet header. Additionally and/or alternatively, the offset(s) can extend into an SDAP SDU such that the ciphering and/or integrity protection includes a portion of the IP data. Note that the offset(s) can be configured to extend to the SDAP SDU to cover any portion of the SDAP SDU up to all of the higher layer data.

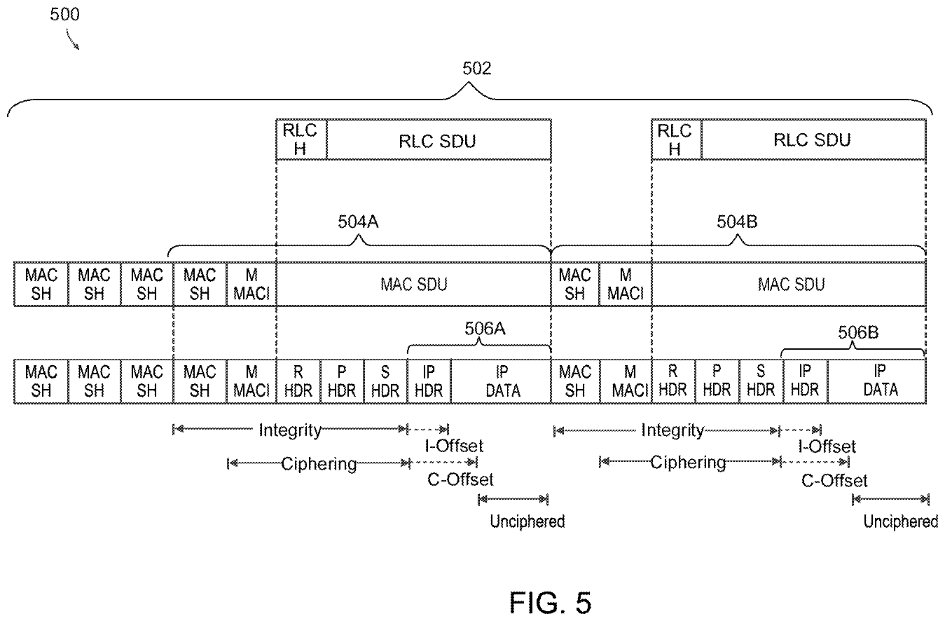

FIG. 5 illustrates an example ciphering and integrity protection 500 in the MAC layer using ciphering and integrity protection offsets, according to some implementations. As shown in FIG. 5, a transport block 502 includes two MAC subPDUs 504A, 504B. The UE 202 is configured to cipher the SDAP header (S HDR), the PDCP header (P HDR), the RLC header (R HDR), and the M MAC-I in the MAC subPDUs 504A, 504B. Additionally, the UE 202 is configured to integrity protect the MAC SH, the SDAP header (S HDR), the PDCP header (P HDR), and the RLC header (R HDR) in each of the MAC subPDUs 504A, 504B. As also shown in FIG. 5, the UE 202 uses an I-Offset to extend the integrity protection and a C-Offset to extend the ciphering. In the example 500, the I-Offset extends the integrity protection to include an IP header of SDAP SDUs 506A, 506B. And the C-Offset extends the ciphering to include the IP header and a portion of IP data of the SDUs 506A, 506B.

In some implementations, the C-Offset and the I-Offset are based on one or more factors. The C-Offset and the I-Offset could be either directly based on throughput or on one or more hardware-related capabilities that impact throughput. In some implementations, either or both offset values are based on one or more hardware capabilities (or resources) of the UE 202. As an example, a device that has a maximum throughput of “X” gigabit per second (Gbps) or a corresponding component carrier (CC) envelope can be configured to use ciphering and/or integrity protection offsets up to a preconfigured threshold “Y.” In this example, “X” can be a preconfigured threshold, and the threshold “Y” can be the same or different for the C-Offset and the I-Offset. And in this example, CC envelope is indicative of the number of carriers (e.g., SecondaryCells) a device supports. This impact the maximum throughput that could be achieved on a device. As another example, a device with a certain security class (e.g., highly secure devices) can be configured to support ciphering and/or integrity protection offsets that cover up to the entire SDAP SDU to ensure complete protection of the higher layer data, as needed.

In some other implementations, the ciphering and/or integrity protection offsets may additionally or alternatively be different for different logical channels (LCs), radio bearers (RBs), and/or Quality of Service (QoS). The wireless network 200 can configure the different offsets using higher layer signaling, e.g., RRC signaling, from the base station 204. As an example, the base station 204 can configure the UE 202 with an offset to cipher and/or integrity protect IP+UDP+RTP headers on Voice over NR (VoNR) bearers, IP+TCP headers on Internet bearers, or the entire PDCP SDU on Signaling Radio Bearers (SRBs) (e.g., IP headers and IP payload). In existing systems, traffic on SRBs (e.g., coming from RRC layer) is not ciphered, so ciphering/integrity protection can be extended to cover the traffic on SRBs.

In some other implementations, the ciphering and/or integrity protection offsets may additionally or alternatively be application-specific, perhaps based on Application Layer information. As an example, the UE 202 may be configured to perform full protection for unsecured packets, and header protection for secured packets. The full protection may include ciphering and/or integrity protecting the entire SDAP SDU for DRBs. In such implementations, to facilitate application-specific protection, the UE 202 is configured to indicate the ciphering and/or integrity protection offsets to the base station 204 using in-band signaling within the MAC subheader.

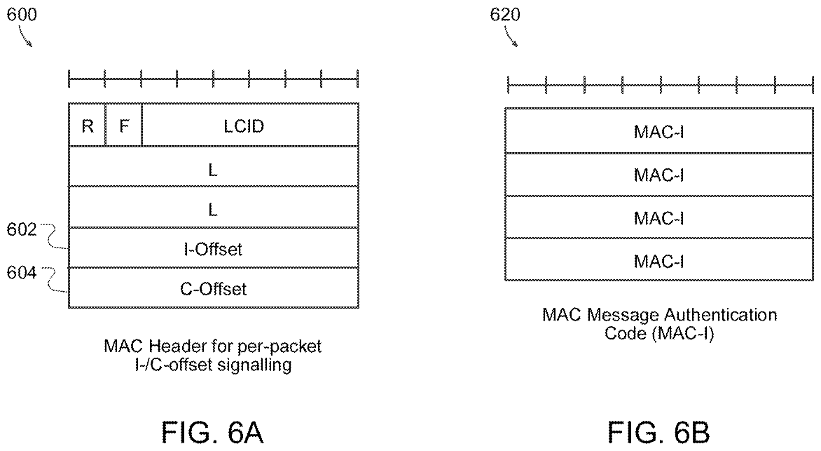

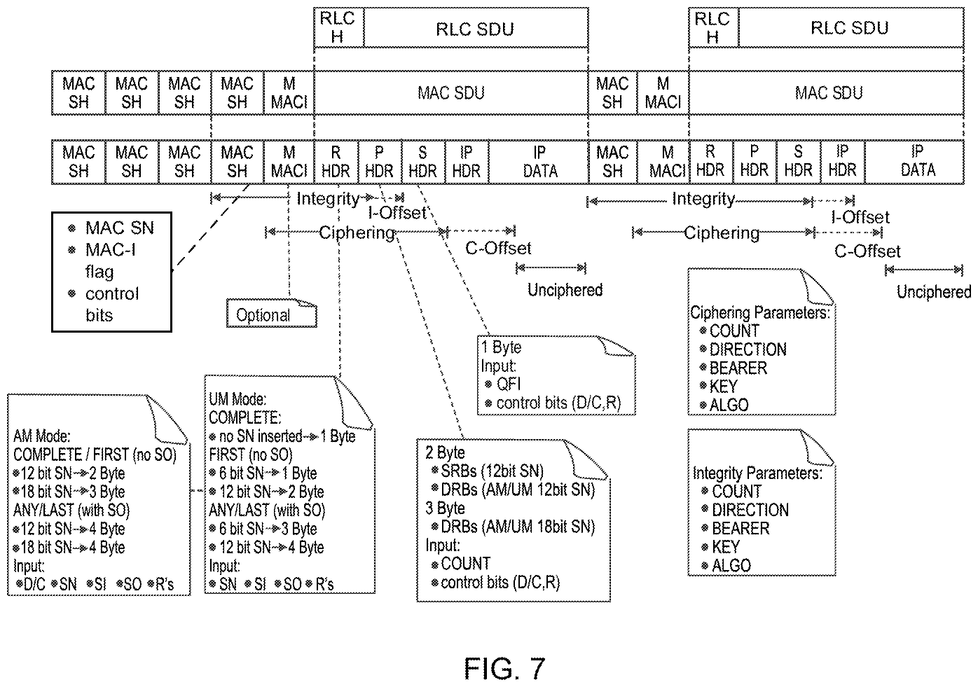

FIG. 6A illustrates an example MAC subheader 600, according to some implementations. The UE 202 can use the MAC subheader 600 for in-band signaling of ciphering and/or integrity protection offsets. As shown in FIG. 6A, the MAC subheader 600 includes an integrity protection offset (I-Offset) field 602 and a ciphering offset (C-Offset) field 604, which can be used for in-band signaling of the ciphering and/or integrity protection offsets.

In other implementations, the ciphering and/or integrity protection offsets may additionally or alternatively be standardized indices in a mapping table or can be specified for exact byte numbers. In such implementations, the UE 202 is configured to indicate the ciphering and/or integrity protection offsets to the base station 204 using in-band signaling within the MAC subheader, e.g., MAC subheader 600. And to signal the ciphering and/or integrity protection offsets for exact byte numbers, the UE 202 is configured to select the lengths of the I-Offset field 602 and the C-Offset field 604 based on the maximum byte values.

FIG. 6B illustrates an example M MAC-I 620, according to some implementations. The M MAC-I can be the M MAC-I shown in FIGS. 3, 4, and 5. In this example, the M MAC-I 620 is 4 octets, but can be other sizes as well.

In the described implementations, the UE 202 ciphers and integrity protects SDAP, PDCP, RLC headers. Thus, unlike in existing networks, manipulation of these headers is not possible. Additionally, the UE 202 integrity protects MAC subheaders and MAC CEs. Thus, unlike in existing systems, manipulation of MAC subheaders and MAC CEs is not possible. Further, the UE 202 can selectively cipher and/or integrity protect IP headers and/or IP data (or a portion thereof) based on ciphering and integrity protection offsets. Thus, the UE 202 has greater flexibility for tailoring the desired ciphering and/or integrity protection based on the scenario or application. Also, by implementing the security mechanisms in the MAC layer, the disclosed implementations avoid complex cross layer handling present in existing systems.

Furthermore, the number of bytes that the UE 202 processes for protection is significantly reduced compared to existing networks. The following examples illustrate the reduction in the number of bytes. In these examples, the C-Offset covers a minimum IP header, where the minimum IP header size of an IPv4 header is 20 bytes and the minimum IP header size of an IPv6 header size is 40 bytes. In a first example, a transport block includes an 8000-byte IP packet and 16-byte L2 headers. In this example, the UE 202 ciphers/integrity protects the L2 headers and the IP header. If the IP header is an IPv4 header, the number of bytes ciphered/integrity protected is 36 bytes out of 8016 bytes, which is approximately 0.4% of the MAC PDU. If the IP header is an IPv6 header, the number of bytes ciphered/integrity protected is 56 bytes out of 8016 bytes, which is approximately 0.7% of the MAC PDU. In a second example, a transport block includes a 1500-byte IP packet and 16-byte L2 headers. In this example, the UE 202 ciphers/integrity protects the L2 headers, excluding the MAC SH, and the IP header. If the IP header is an IPv4 header, the number of bytes ciphered/integrity protected is 36 bytes out of 1516 bytes, which is approximately 2.3% of the MAC PDU. If the IP header is an IPv6 header, the number of bytes ciphered/integrity protected is 56 bytes out of 1516 bytes, which is approximately 3.7% of the MAC PDU. Thus, compared to existing networks that cipher/integrity protects +95% of MAC PDUs, the disclosed implementations achieve a significant reduction in ciphering/integrity protection requirements.

The described implementations also achieve faster and more efficient computational processing than existing systems. As an example, unlike in existing systems that arrange L2 headers and MAC-I non-consecutively, the L2 headers and MAC-I are arranged consecutively in the MAC subPDU. Ciphering of consecutive data is faster than ciphering non-consecutive data. As another example, “on-the-fly” processing is possible. Specifically, at a short time after the UE 202 receives an uplink (UL) grant and assembles the transport block, hardware accelerators of the

UE 202 create and cipher the L2 header block on-the-fly, and then push the ciphered L2 header into L1 memory. This operation is more memory efficient than existing systems. Furthermore, because the protection is applied on a MAC subPDU level (and not on the transport block level), offline processing of major parts of the transport block is possible. For example, the UE 202 can prepare and store MAC subPDUs until the transport block assembly starts. Note that although in the described implementations the MAC subheaders and CEs are unciphered, they cannot be manipulated due to integrity protection.

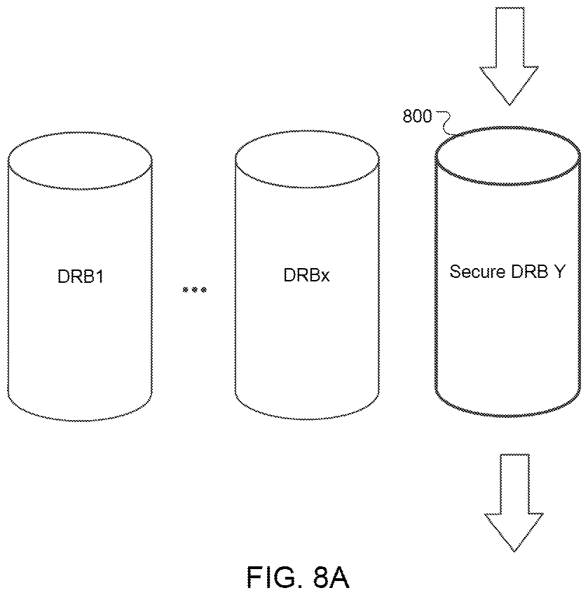

In some implementations, L2 header generation, integrity protection, and ciphering can be performed at a single point with efficient hardware support. This is, in part, possible because parameters can be derived from each other or can be easily generated. As an example, the parameter SDAP QoS Flow ID (QFI) is the same for all the packets belonging to the same QoS flow. As another example, the parameters PDCP COUNT, RLC SN, and MAC SN increase with each subPDU. Additionally, a transport block that includes “X” MAC subPDUs belonging to 1 logical channel, only requires 1 parameter set to configure the hardware. The remaining parameters can be generated, ciphered, and concatenated in L1 memory. FIG. 7 illustrates example input parameters for L2 header generation, integrity protection, and ciphering, according to some implementations. As shown in FIG. 7, the input parameters for L2 header generation, integrity protection, and ciphering include ciphering/integrity parameters, header generation parameters, I-Offset (if applicable), C-Offset (if applicable), and a list of all IP packet pointers. The ciphering/integrity parameters include COUNT (MAC based), DIRECTION, BEARER, KEY, and ALGO. The header parameters for SDAP and PDCP include QFI and control bits (e.g., D/C, R). The RLC header parameters include Mode Flag (e.g., Unacknowledged Mode [UM] and Acknowledged Mode [AM]), control bits (e.g., D/C, R), SN, Segment Indicator (SI), and Segment Offset (SO). The MAC subheader parameters include MAC SN, MAC-I flag, and control bits. For each MAC subPDU, the header creation and ciphering is done in a single-step operation at the moment of transport block assembly without incremental header creation and ciphering. In existing systems, however, first the PDCP PDU is ciphered and is then handled by RLC/MAC to add all L2 headers, which is a slower multi-step process.

In some implementations, the wireless network 200 may define a secure data radio bearer (DRB). The secure DRB may use ciphering and/or integrity protection offsets to protect up to the entire IP data packet. As described in more detail below, the UE 202 can map secured data (e.g., E2E encrypted data) to a regular DRB and map unsecured data to the secure DRB. By mapping the unsecured data to the secure DRB, the UE 202 ensure that all data is transmitted securely. In one example, the wireless network 200 configures the secure DRB with limited throughput, latency, and priority to reduce the hardware requirements compared to existing systems.

In some implementations, mapping the unsecured traffic to the secure DRB is network controlled or UE controlled. In the network-controlled mapping, the wireless network 200 configures packet filters to route the unsecured packets to the secure QoS Flow and from there to the secure DRB. However, this requires knowledge on the network side about the applications running on the UE 202 and whether those applications are secure (e.g., employ E2E encryption). In the UE controlled mapping, the UE 202 creates UL packet filters to route the unsecured packets to the secure QoS Flow and from there to the secure DRB.

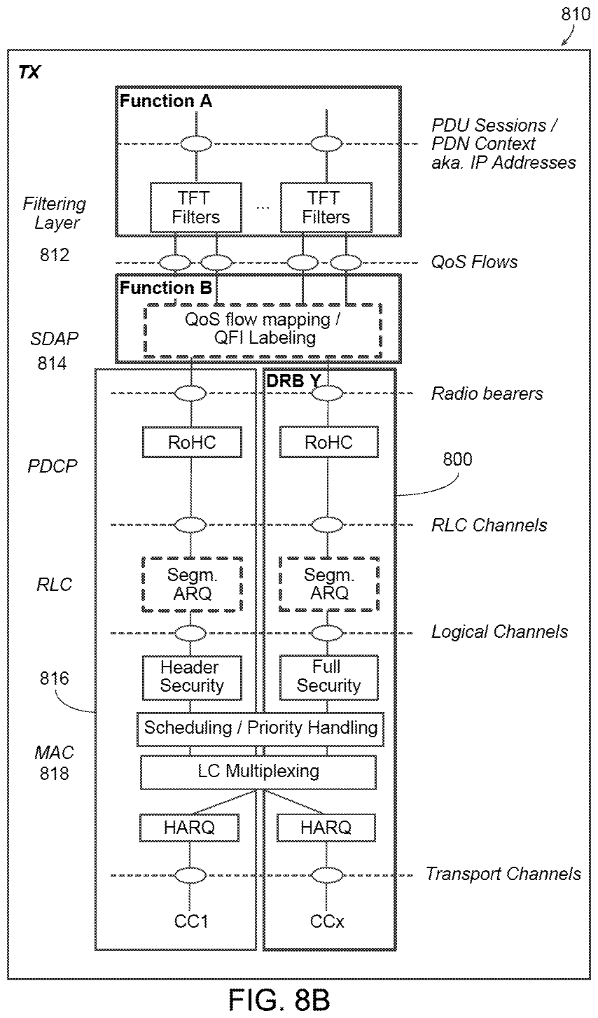

FIG. 8A, 8B illustrate examples of mapping unsecured data to a secure DRB, according to some implementations. Specifically, FIG. 8A illustrates a secure DRB Y (also labelled as DRB 800). In addition to configuring one or more “regular” DRBs, e.g., DRB 1, a network can configure the secure DRB Y. FIG. 8B illustrates a transmitter (Tx) architecture 810 for mapping data to the secure DRB Y. The Tx architecture 810 includes a filtering layer 812. In the filtering layer 812, the transmitter implements a “Function A” that includes Traffic Flow Template (TFT) filters and that is configured to map data to QoS flows. In an example, Function A is configured to map unsecured data to a specific QoS flow associated with the secure DRB Y, e.g., “QoS Flow X,” and secured data to another QoS flow.

The QoS flows carry the data to an SDAP layer 814 that implements a Function B. Function B is configured to perform QoS flow mapping and QFI labeling. In one example, Function B is configured to map QoS Flow X to the secure DRB Y. Function B is also configured to map QoS flows not associated with the secure DRB Y to other DRBs, e.g., regular DRB 816. As shown in FIG. 8B, a MAC layer 818 applies different types of security protection to the different DRBs. Specifically, the MAC layer 818 applies full security (e.g., complete ciphering and/or integrity protection) to the unsecured data in the secure DRB Y. As an example, the MAC layer 818 can use ciphering and integrity protection offsets to extend the ciphering and/or integrity protection from the L2 headers to the IP data. As described previously, the offsets can be used to extend the ciphering and/or integrity protection to cover up to the entire IP packet. In the regular DRB 816, however, the MAC layer 818 applies header security (e.g., L2 header ciphering and/or integrity protection).

In some implementations, the wireless network 200 is configured to use a reversed “reflective QoS” as a corresponding filter in the downlink (DL). In these implementations, the UE 202 indicates Reflective QoS Indication (RQI)/Reflective QoS flow to DRB mapping Indication

(RDI) in the UL. The wireless network 200 configures the DL filters accordingly so that incoming DL packets get mapped in the same way to the secure QoS Flow and from there to the secure DRB.

In the described implementations, the UE 202 ciphers and integrity protects SDAP, PDCP, RLC headers. Thus, unlike in existing networks, manipulation of these headers is not possible. Additionally, the UE 202 integrity protects MAC subheaders and MAC CEs. Thus, unlike in existing systems, manipulation of MAC subheaders and MAC CEs is not possible. Further, the UE 202 can selectively cipher and/or integrity protect IP headers and/or IP data (or a portion thereof) based on ciphering and integrity protection offsets in the secure DRB. Thus, the UE 202 has greater flexibility for tailoring the desired ciphering and/or integrity protection based on the scenario or application. And, in the regular DRBs, the focus is on ciphering and integrity protection of the non-IP data parts. Therefore, the amount of data that needs to be protected is drastically reduced.

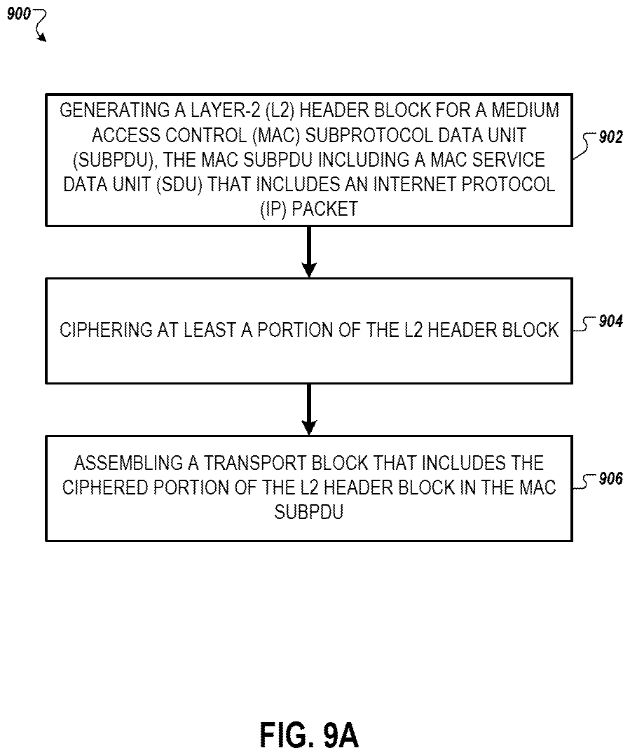

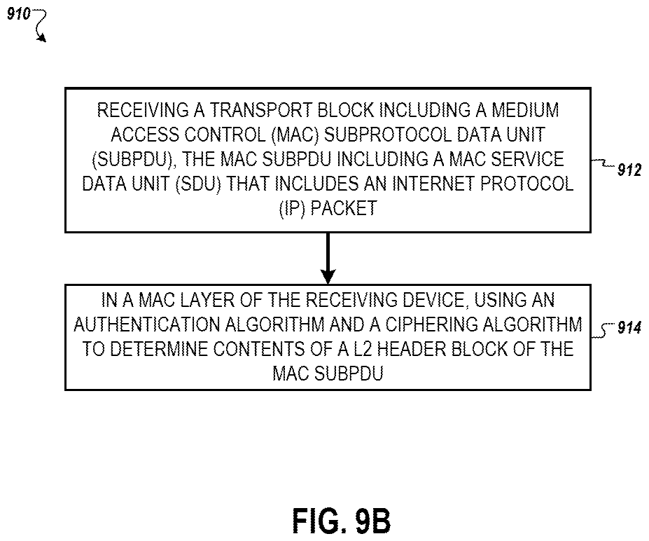

FIG. 9A illustrates a flowchart of an example method 900, according to some implementations. For clarity of presentation, the description that follows generally describes method 900 in the context of the other figures in this description. For example, method 900 can be performed by the UE 202 of FIG. 2. It will be understood that method 900 can be performed, for example, by any suitable system, environment, software, hardware, or a combination of systems, environments, software, and hardware, as appropriate. In some implementations, various steps of method 900 can be run in parallel, in combination, in loops, or in any order.

At step 902, method 900 involves generating a layer-2 (L2) header block for a medium access control (MAC) subprotocol data unit (subPDU), the MAC subPDU including a MAC service data unit (SDU) that includes an internet protocol (IP) packet.

At step 904, method 900 involves ciphering at least a portion of the L2 header block.

At step 906, method 900 involves assembling a transport block that includes the ciphered portion of the L2 header block in the MAC subPDU.

In some implementations, the L2 header block includes at least one of a MAC Sub-PDU header (MAC SH), a MAC Message Authentication Code (M MACI), a Service Data Adaptation Protocol (SDAP) header, a Packet Data Convergence Protocol (PDCP) header, or a Radio Link Control (RLC) header.

In some implementations, the portion of the L2 header block involves the M MACI, the SDAP header, the PDCP header, and the RLC header.

In some implementations, method 900 further involves ciphering, based on a ciphering offset, at least a portion of the MAC SDU.

In some implementations, the ciphered portion of the MAC SDU includes at least one of: an IP header or a portion of the IP packet.

In some implementations, the portion is a first portion, and method 900 further involves integrity protecting at least a second portion of the L2 header block.

In some implementations, the second portion of the L2 header block involves one of: a first MAC Sub-PDU header (MAC SH) of a plurality of MAC SHs, a Service Data Adaptation Protocol (SDAP) header, a Packet Data Convergence Protocol (PDCP) header, and a Radio Link Control (RLC) header; the first MAC SH; the plurality of MAC SHs; or the plurality of MAC SHs, the SDAP header, the PDCP header, and the RLC header.

In some implementations, method 900 further involves integrity protecting, based on an integrity protection offset, at least a portion of the MAC SDU, where the integrity protected portion of the MAC SDU includes at least one of: an IP header or a portion of the IP packet.

In some implementations, the IP packet is a first encrypted IP packet, and the method further involves: establishing a secure data radio bearer (DRB) with a receiver; mapping, using a traffic flow template (TFT) filter, a second unsecured IP packet to a secure quality of service (QoS) flow, where the unsecured IP packet is not ciphered or integrity protected; and mapping the secure QoS flow to the secure DRB.

In some implementations, method 900 further involves in the secure DRB, performing at least one of: ciphering the unsecured IP packet; or integrity protecting the unsecured IP packet.

In some implementations, method 900 further involves mapping the first encrypted IP packet to a second DRB different from the secure DRB.

In some implementations, method 900 further involves transmitting the transport block to a receiver.

In some implementations, method 900 further involves performing, based on at least one of an integrity protection offset or a ciphering offset, at least one of ciphering or integrity protection of at least a portion of the MAC SDU, where the at least one of the integrity protection offset or the ciphering offset has a corresponding standardized index in a mapping table.

In some implementations, method 900 further involves determining the at least one of the integrity protection offset or the ciphering offset based on one of:
a hardware capability of a transmitter performing the least one of ciphering or integrity protection,
a logical channel (LC) for the IP packet,
a radio bearer (RB) type for the IP packet,
a Quality of Service (QoS) flow for the IP packet,
application layer information for the IP packet, or
a security class of the transmitter.

In some implementations, determining the at least one of the integrity protection offset or the ciphering offset is based on the RB type involves: determining that the RB type is a Voice over IP (VoIP); and in response, determining that the at least one of the integrity protection offset or the ciphering offset covers at least one of an IP header, a User Datagram Protocol (UDP) header, or a Real-time Transport Protocol (RTP) header.

In some implementations, determining the at least one of the integrity protection offset or the ciphering offset is based on the security class of the transmitter involves: determining that the transmitter is assigned a secure security class; and in response, determining that the at least one of the integrity protection offset or the ciphering offset covers the IP packet and an IP header.

In some implementations, method 900 further involves determining the at least one of the integrity protection offset or the ciphering offset by selecting portions of the IP packet to cipher and/or integrity protect; including the at least one of the integrity protection offset or the ciphering offset in a MAC subheader to signal the offsets to a receiver.

FIG. 9B illustrates a flowchart of an example method 910, according to some implementations. For clarity of presentation, the description that follows generally describes method 910 in the context of the other figures in this description. For example, method 910 can be performed by base station 204 of FIG. 2. It will be understood that method 910 can be performed, for example, by any suitable system, environment, software, hardware, or a combination of systems, environments, software, and hardware, as appropriate. In some implementations, various steps of method 910 can be run in parallel, in combination, in loops, or in any order.

At step 912, method 910 involves receiving a transport block including a medium access control (MAC) subprotocol data unit (subPDU), the MAC subPDU including a MAC service data unit (SDU) that includes an internet protocol (IP) packet.

At step 914, method 910 involves in a MAC layer of the receiving device, using an authentication algorithm and a ciphering algorithm to determine contents of a L2 header block of the MAC subPDU.

In some implementations, method 910 further involves determining, based on an integrity protection offset and a ciphering offset, a protected portion of the IP packet and an IP header; and in the MAC layer of the receiving device, using the authentication algorithm and the ciphering algorithm to determine contents of the protected portion of the IP packet and the IP header.

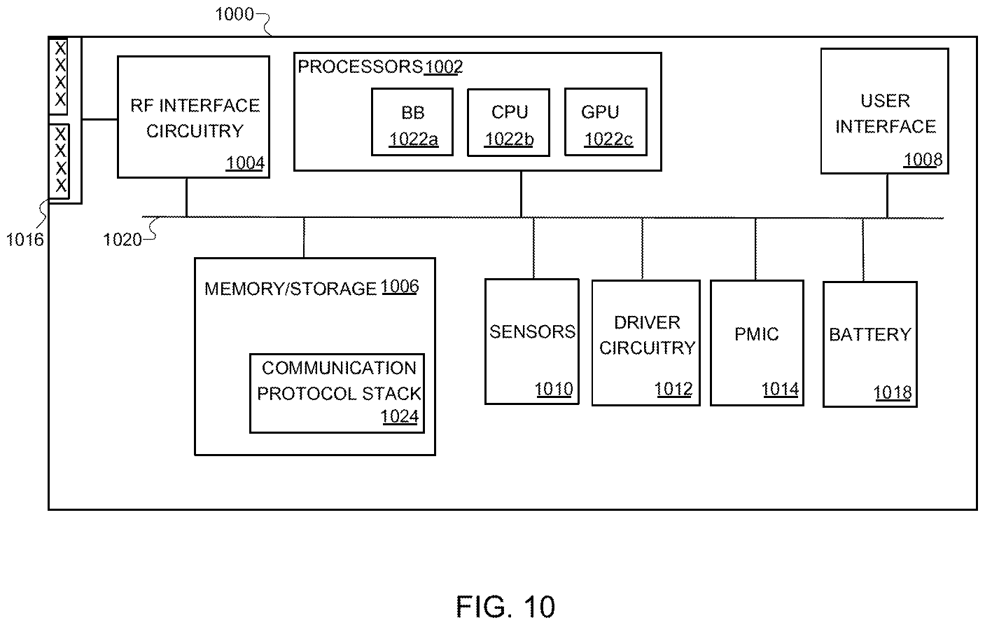

FIG. 10 illustrates an example UE 1000, according to some implementations. The UE 1000 may be similar to and substantially interchangeable with UE 202 of FIG. 2.

The UE 1000 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1000 may include processors 1002, RF interface circuitry 1004, memory/storage 1006, user interface 1008, sensors 1010, driver circuitry 1012, power management integrated circuit (PMIC) 1014, antenna 1016, and battery 1018. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1020, which may represent any type of interface, input/output, bus (local, system, or expansion), transmission line, trace, optical connection, etc. that allows various circuit components (on common or different chips or chipsets) to interact with one another.

The processors 1002 may include processor circuitry such as, for example, baseband processor circuitry (BB) 1022A, central processor unit circuitry (CPU) 1022B, and graphics processor unit circuitry (GPU) 1022C. The processors 1002 may include any type of circuitry or processor circuitry that executes or otherwise operates computer-executable instructions, such as program code, software modules, or functional processes from memory/storage 1006 to cause the UE 1000 to perform operations as described herein.

In some implementations, the baseband processor circuitry 1022A may access a communication protocol stack 1024 in the memory/storage 1006 to communicate over a 3GPP compatible network. In general, the baseband processor circuitry 1022A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1004. The baseband processor circuitry 1022A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1006 mayinclude one or more non-transitory, computer-readable media that includes instructions (for example, communication protocol stack 1024) that may be executed by one or more of the processors 1002 to cause the UE 1000 to perform various operations described herein. The memory/storage 1006 include any type of volatile or non-volatile memory that may be distributed throughout the UE 1000. In some implementations, some of the memory/storage 1006 may be located on the processors 1002 themselves (for example, L1 and L2 cache), while other memory/storage 1006 is external to the processors 1002 but accessible thereto via a memory interface. The memory/storage 1006 mayinclude any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1004 mayinclude transceiver circuitry and radio frequency front module (RFEM) that allows the UE 1000 to communicate with other devices over a radio access network. The RF interface circuitry 1004 mayinclude various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna 1016 and proceed to filter and amplify (with a low-noise amplifier) the signal. The signal may be provided to a receiver of the transceiver that downconverts the RF signal into a baseband signal that is provided to the baseband processor of the processors 1002.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1016. In various implementations, the RF interface circuitry 1004 may be configured to transmit/receive signals in a manner compatible with NR access technologies.

The antenna 1016 mayinclude antenna elements to convert electrical signals into radio waves to travel through the air and to convert received radio waves into electrical signals. The antenna elements may be arranged into one or more antenna panels. The antenna 1016 may have antenna panels that are omnidirectional, directional, or a combination thereof to enable beamforming and multiple input, multiple output communications. The antenna 1016 mayinclude microstrip antennas, printed antennas fabricated on the surface of one or more printed circuit boards, patch antennas, phased array antennas, etc. The antenna 1016 mayhave one or more panels designed for specific frequency bands including bands in FR1 or FR2.

The user interface 1008 includes various input/output (I/O) devices designed to enable user interaction with the UE 1000. The user interface 1008 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1000.

The sensors 1010 mayinclude devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers;

microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1012 mayinclude software and hardware elements that operate to control particular devices that are embedded in the UE 1000, attached to the UE 1000, or otherwise communicatively coupled with the UE 1000. The driver circuitry 1012 mayinclude individual drivers allowing other components to interact with or control various input/output (I/O) devices that may be present within, or connected to, the UE 1000. For example, driver circuitry 1012 may include a display driver to control and allow access to a display device, a touchscreen driver to control and allow access to a touchscreen interface, sensor drivers to obtain sensor readings of sensors 1010 and control and allow access to sensors 1010, drivers to obtain actuator positions of electro-mechanic components or control and allow access to the electro-mechanic components, a camera driver to control and allow access to an embedded image capture device, audio drivers to control and allow access to one or more audio devices.

The PMIC 1014 may manage power provided to various components of the UE 1000. In particular, with respect to the processors 1002, the PMIC 1014 may control power-source selection, voltage scaling, battery charging, or DC-to-DC conversion.

In some implementations, the PMIC 1014 may control, or otherwise be part of, various power saving mechanisms of the UE 1000. A battery 1018 may power the UE 1000, although in some examples the UE 1000 may be mounted deployed in a fixed location, and may have a power supply coupled to an electrical grid. The battery 1018 may be a lithium ion battery, a metal-air battery, such as a zinc-air battery, an aluminum-air battery, a lithium-air battery, and the like. In some implementations, such as in vehicle-based applications, the battery 1018 may be a typical lead-acid automotive battery.

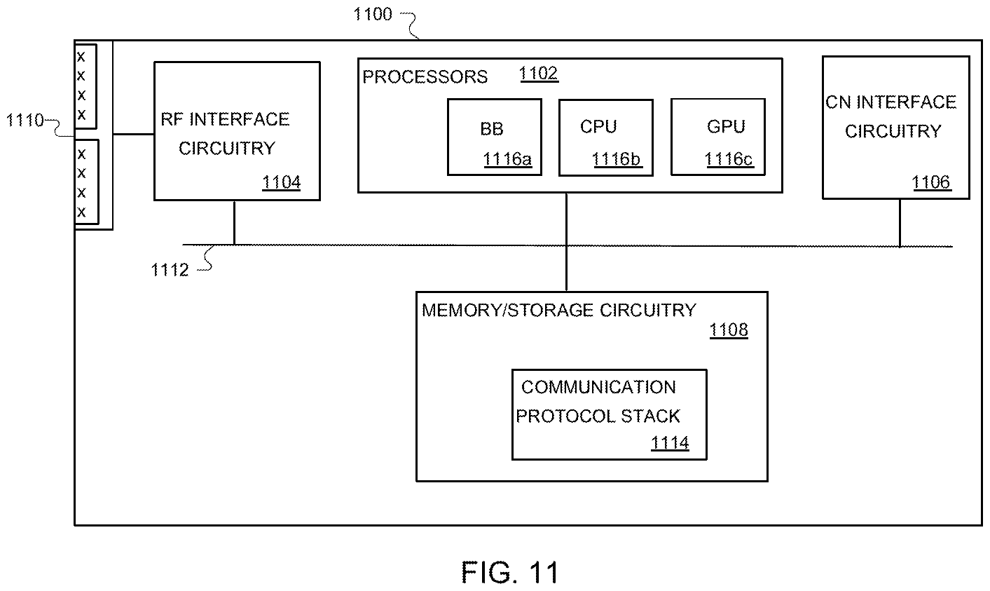

FIG. 11 illustrates an example access node 1100 (e.g., a base station or gNB), according to some implementations. The access node 1100 may be similar to and substantially interchangeable with base station 204. The access node 1100 mayinclude processors 1102, RF interface circuitry 1104, core network (CN) interface circuitry 1106, memory/storage circuitry 1108, and antenna 1110.

The components of the access node 1100 may be coupled with various other components over one or more interconnects 1112. The processors 1102, RF interface circuitry 1104, memory/storage circuitry 1108 (including communication protocol stack 1114), antenna 1110, and interconnects 1112 may be similar to like-named elements shown and described with respect to

FIG. 10. For example, the processors 1102 mayinclude processor circuitry such as, for example, baseband processor circuitry (BB) 1116A, central processor unit circuitry (CPU) 1116B, and graphics processor unit circuitry (GPU) 1116C.

The CN interface circuitry 1106 may provide connectivity to a core network, for example, a 5th Generation Core network (5GC) using a 5GC-compatible network interface protocol such as carrier Ethernet protocols, or some other suitable protocol. Network connectivity may be provided to/from the access node 1100 via a fiber optic or wireless backhaul. The CN interface circuitry 1106 mayinclude one or more dedicated processors or FPGAs to communicate using one or more of the aforementioned protocols. In some implementations, the CN interface circuitry 1106 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). According to various implementations, the access node 1100 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1100 may be implemented as one or more software entities running on server computers as part of a virtual network, which may be referred to as a CRAN and/or a virtual baseband unit pool (vBBUP). In V2X scenarios, the access node 1100 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A method comprising:
generating a layer-2 (L2) header block for a medium access control (MAC) subprotocol data unit (subPDU), the MAC subPDU comprising a MAC service data unit (SDU) that includes an internet protocol (IP) packet;
ciphering at least a portion of the L2 header block; and
assembling a transport block that includes the ciphered portion of the L2 header block in the MAC subPDU.

2. The method of claim 1, wherein the L2 header block comprises at least one of a MAC Sub-PDU header (MAC SH), a MAC Message Authentication Code (M MACI), a Service Data Adaptation Protocol (SDAP) header, a Packet Data Convergence Protocol (PDCP) header, or a Radio Link Control (RLC) header.

3. The method of claim 2, wherein the portion of the L2 header block comprises the M MACI, the SDAP header, the PDCP header, and the RLC header.

4. The method of claim 1, further comprising:
ciphering, based on a ciphering offset, at least a portion of the MAC SDU.

5. The method of claim 4, wherein the ciphered portion of the MAC SDU includes at least one of: an IP header or a portion of the IP packet.

6. The method of claim 1, wherein the portion is a first portion, and wherein the method further comprises:
integrity protecting at least a second portion of the L2 header block.

7. The method of claim 6, wherein the second portion of the L2 header block comprises one of:
(i) a first MAC Sub-PDU header (MAC SH) of a plurality of MAC SHs, a Service Data Adaptation Protocol (SDAP) header, a Packet Data Convergence Protocol (PDCP) header, and a Radio Link Control (RLC) header;
(ii) the first MAC SH;
(iii) the plurality of MAC SHs; or
(iv) the plurality of MAC SHs, the SDAP header, the PDCP header, and the RLC header.

8. The method of claim 6, further comprising:
integrity protecting, based on an integrity protection offset, at least a portion of the MAC SDU, wherein the integrity protected portion of the MAC SDU includes at least one of: an IP header or a portion of the IP packet.

9. The method of claim 1, wherein the IP packet is a first encrypted IP packet, and the method further comprising:
establishing a secure data radio bearer (DRB) with a receiver;
mapping, using a traffic flow template (TFT) filter, a second unsecured IP packet to a secure quality of service (QoS) flow, wherein the unsecured IP packet is not ciphered or integrity protected; and
mapping the secure QoS flow to the secure DRB.

10. The method of claim 9, further comprising:
in the secure DRB, performing at least one of:
ciphering the unsecured IP packet; or
integrity protecting the unsecured IP packet.

11. The method of claim 9, further comprising:
mapping the first encrypted IP packet to a second DRB different from the secure DRB.

12. The method of claim 1, further comprising:
transmitting the transport block to a receiver.

13. The method of claim 1, further comprising:
performing, based on at least one of an integrity protection offset or a ciphering offset, at least one of ciphering or integrity protection of at least a portion of the MAC SDU, wherein the at least one of the integrity protection offset or the ciphering offset has a corresponding standardized index in a mapping table.

14. The method of claim 13, further comprising determining the at least one of the integrity protection offset or the ciphering offset based on one of:
a hardware capability of a transmitter performing the least one of ciphering or integrity protection,
a logical channel (LC) for the IP packet,
a radio bearer (RB) type for the IP packet,
a Quality of Service (QoS) flow for the IP packet,
application layer information for the IP packet, or
a security class of the transmitter.

15. The method of claim 14, wherein determining the at least one of the integrity protection offset or the ciphering offset is based on the RB type comprises:
determining that the RB type is a Voice over IP (VoIP); and
in response, determining that the at least one of the integrity protection offset or the ciphering offset covers at least one of an IP header, a User Datagram Protocol (UDP) header, or a Real-time Transport Protocol (RTP) header.

16. The method of claim 14, wherein determining the at least one of the integrity protection offset or the ciphering offset is based on the security class of the transmitter comprises:
determining that the transmitter is assigned a secure security class; and
in response, determining that the at least one of the integrity protection offset or the ciphering offset covers the IP packet and an IP header.

17. The method of claim 13, the method further comprising:
determining the at least one of the integrity protection offset or the ciphering offset by selecting portions of the IP packet to cipher and/or integrity protect; and
including the at least one of the integrity protection offset or the ciphering offset in a MAC subheader to signal the offsets to a receiver.

18. A method to be performed by a receiving device, the method comprising:
receiving a transport block comprising a medium access control (MAC) subprotocol data unit (subPDU), the MAC subPDU comprising a MAC service data unit (SDU) that includes an internet protocol (IP) packet; and'
in a MAC layer of the receiving device, using an authentication algorithm and a ciphering algorithm to determine contents of a L2 header block of the MAC subPDU.

19. The method of claim 18, the method further comprising:
determining, based on an integrity protection offset and a ciphering offset, a protected portion of the IP packet and an IP header; and
in the MAC layer of the receiving device, using the authentication algorithm and the ciphering algorithm to determine contents of the protected portion of the IP packet and the IP header.

20. An apparatus comprising processing circuitry configured to perform operations comprising:
generating a layer-2 (L2) header block for a medium access control (MAC) subprotocol data unit (subPDU), the MAC subPDU comprising a MAC service data unit (SDU) that includes an internet protocol (IP) packet;
ciphering at least a portion of the L2 header block; and
assembling a transport block that includes the ciphered portion of the L2 header block in the MAC subPDU.
